(19) United States
(12) Patent Application Publication
(10) Pub. No.: US 2025/0389400 A1
(43) Pub. Date: Dec. 25, 2025

(54) OUTDOOR LIGHTING SYSTEM

(71) Applicant: KORRUS, INC., Los Angeles, CA (US)

(72) Inventors: Paul Kenneth Pickard, Los Angeles, CA (US); Raghuram L.V. Petluri, Los Angeles, CA (US)

(21) Appl. No.: 19/222,261

(22) Filed: May 29, 2025

Related U.S. Application Data
(63) Continuation of application No. PCT/US23/81634, filed on Nov. 29, 2023.
(60) Provisional application No. 63/428,627, filed on Nov. 29, 2022.

(51) Int. Cl. F21S 8/08; F21V 23/02; F21W 131/103; F21Y 113/13; H05B 45/20

(52) U.S. Cl. CPC F21S 8/086; F21V 23/02; H05B 45/20; F21W 2131/103; F21Y 2113/13

(57) ABSTRACT

An outdoor lighting system for emitting emitted light, comprising: (a) a first light source having a first LED and first light converting material(s) for emitting said first light, said first light being a green light; (b) a second light source having a second LED and light converting material(s) for emitting said second light, said second light being a red light; (c) wherein said first light source and said second light source do not excite said second and first light converting material(s), respectively; and (d) a power supply for powering said first and second light sources to emit said first emitted light in a first mode, said first emitted light in having an overall SPD power and a blue SPD power, wherein said blue SPD power is no greater than 2% of said overall SPD power, said first emitted light being at least 0.005 Duv above the blackbody curve.

### CROSS REFERENCE TO RELATED APPLICATIONS

The present patent application claims the benefit of U.S. Provisional Patent Application 63/428,627, filed Nov. 29, 2022, the entire disclosures of each of which are hereby incorporated by reference.

### FIELD OF INVENTION

The present invention relates, generally, to outdoor lighting, and, more specifically, to outdoor lighting that minimizes disruption to circadian cycles, Dark Skies, and the ecosystem in general.

### BACKGROUND OF INVENTION

Outdoor lighting systems, such as street lighting, area lighting, and outdoor floods, were among the first adopters of LEDs as light sources. The appeal of LEDs for these applications was multifaceted. First, early LEDs with low (70) CRI were quite efficient, quickly surpassing the energy efficiency of High Pressure Sodium (HPS), Low Pressure Sodium (LPS) and Metal Halide (MH) lamps. Additionally, well-designed outdoor fixtures offered substantially longer “no maintenance” lifetimes vs incumbent technologies that required dedicated crews to constantly “relamp” fixtures with HPS, LPS or MH lamps. LED fixtures are also dimmable (or at least multi-level settable) allowing for motion sensors to vary lighting levels from dim to bright depending on the presence of people. Finally, LED fixture tend to fail passively, whereas arc lamps left in service for too long after exhibiting failure modes (blinking, substantial drop in output) could fail aggressively resulting in sparks/fire/heat all of which pose a significant forest fire risk. Thus, outdoor lighting is an obvious application for LED technology: lower energy costs, long lifetimes, little to no maintenance costs, and no concerns about dangerous lamp failures.

The initial broad adoption of LED technology in outdoor lighting applications was without recognition of the deleterious effects of such installations. Specifically, early street lighting LED luminaires were commonly designed with cooler CCTs (4000K to 6500K) which were more broadly available at the time, had brighter light output, were more energy efficient, and more cost-effective. However, the bright, cool outdoor lighting near residential and mixed-use areas caused sleep disruption with residents, and the cool bluish light was generally regarded as unpleasant. The bright, cool light also caused bird migrations to veer into cityscapes, disrupting migration patterns and causing increased bird/skyscraper collisions. Additionally, this light had a broad impact on ecosystems, causing plants to bloom out of season due, and disruption in the nighttime/daytime behavior of mammals, insects, reptiles, and birds. Finally, such bright, cool light emitted from street and area lighting causes increased “ground bounce,” further diminishing the view of the stars in urban cityscapes.

By way of background, the detailed spectral power distributions (SPDs) of streetlights can be simplified for physiological reasons in terms of their scotopic-photopic (s/p) ratio for peripheral detection. The scotopic-photopic (s/p) ratio has been a useful way to describe the spectral characteristics of visual stimuli that need to be seen in the periphery. Peripheral detection depends exclusively upon rods under starlight [scotopic, V′(λ), spectral sensitivity], and exclusively upon cones during the day [photopic, V(λ) or V10(λ), spectral sensitivity]. The s/p ratio has been particularly useful for characterizing streetlights, because, at street lighting levels both rods and cones are operating simultaneously. Since V′(λ) represents the spectral sensitivity at very low light levels and V10(λ) at high light levels, any streetlight, no matter its spectral power distribution, can be described simply in terms of its s/p ratio. A high s/p ratio translates to high sky glow, high circadian disruption, and high impact on impact on flora/fauna.

The response to these issues was to modify the spectral output to reduce dramatically the blue, violet and UV content of outdoor fixtures, thus resulting in the implementation of 1800K and phosphor amber outdoor lighting. Additionally, application guidelines were issued regarding intensity and optics specifically designed to prevent light egress from the lit environment.

But challenges remain with this new generation of lighting. For example, phosphor amber has very low blue and a very low s/p ratio, which is good, but the light is also very inefficient and has very poor color quality.

While 1800K is more efficient than phosphor amber and has reasonably low blue, it has twice the s/p ratio of phosphor amber. Likewise, 2000K, 2200K and 2400K are viable alternatives—each are progressively more efficient—but each have progressively higher s/p ratios, and blue power percentages that exceed 2%. Generally any light having a blue power percentage that exceeds 2% is considered to be Circadian disruptive.

These conventional outdoor lighting solutions also lack color quality/visual acuity. For example, phosphor amber has very low color quality (e.g., a CRI of ˜40) and visual acuity—everything renders as orange. 1800K is an improvement over phosphor amber, but still only extends the spectral width marginal amounts into red. 2000K, 2200K, and 2400K render progressively less orange (including more yellow, green and blue), but at the cost of increased circadian and environmental disruption and increased sky glow.

Applicant has identified the need for multiple features of an outdoor lighting source capable of minimizing sky glow, circadian disruption, and impact on flora/fauna. To minimize sky glow, the lighting system should have a relatively low s/p ratio. There are no wavelengths that are not disruptive to the natural environment at any level that would be useful for human navigation. Accordingly, to reduce the impact on flora/faunat, it becomes an optimization of the least disruptive set of wavelengths to use for nighttime outdoor lighting. Presently, non phosphor-converted amber (=direct Amber) has a near mono-chromatic solution that can help restore environmental balance and help human navigation, but it is very inefficient and the light is unpleasant. UV, violet and blue light are most disruptive to flora/fauna, thus minimizing these wavelengths is of primary importance. The next most disruptive light colors are Greens/Yellows, with the least disruptive being reds.

For Circadian impact, it is important to minimize blue light between 440-490 nm, keeping it to no more than 2% of total optical SPD power, but ideally less.

Additional desired qualities include visual acuity-ideally a CRI of 80 and a TM-30 Rf of at least 60; efficacy-a minimum of 120 LPW for the source; and adaptability-multiple operating modes allowing for higher visual acuity while people are present, and lower environmental impact while people are not.

To date, no system exists that achieves all these outcomes. Some of the existing solutions are listed in Table 1. None of the solutions provide an acceptable combination of visual acuity, low circadian and environmental impact, low s/p ratio (and therefore minimal sky glow), greater than 120 LPW efficacy, and multi-mode adaptability. The present invention fulfills the above-mentioned need, among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Present invention relates to an outdoor lighting system to create a system capable of achieving substantially sub-2% blue power fraction, good visual acuity, low s/p ratio, acceptable efficacy, and adaptability. To this end, Applicant takes a different approach to creating a nighttime outdoor lighting source. First, Applicant uses two different light source and separates the two different light sources into two distinct components. More specifically, by having one LED device create red light and the other LED device create green light, both with very low blue SPD power fractions, a higher efficacy can be achieved than by using both phosphors in a single package. This is because in a single package, a portion of the light emitted by the green phosphor is reabsorbed by the red phosphor. Separating the colors into two separate devices improves efficacy between 10-20% over a similar color point with combined phosphors. Separating the two colors into distinct devices also facilitates multiple modes of operation. The outdoor lighting system can be run in a combined mode for best visual acuity for humans, or in red-only mode enabling a very low circadian, dark sky, and environmental impact when humans are not present.

Second, Applicant recognizes that conventional “white light” it is not critical for outdoor lighting, and instead uses light having a higher duv than typical for white light sources. By allowing emitted light to be 0.005 to 0.020 duv above the black body curve (BBC), the blue power fraction is minimized. (Conventionally the color manipulation required to reduce the duv and bring the color point back to the BBC would require a higher blue power fraction for the green channel, eliminating one of the benefits of the system.)

Accordingly, in one embodiment, the present invention relates to an outdoor lighting system for emitting emitted light, comprising: (a) a first light source having at least one first LED and one or more first light converting materials for emitting said first light, said first light being a green light; (b) a second light source having at least one second LED and one or more second light converting materials for emitting said second light, said second light being a red light; (c) wherein said first light source and said second light source being isolated such that said first and second LEDs do not excite said second and first light converting materials, respectively; and (d) a power supply for powering said first and second light sources to emit said emitted light in at least a first mode, said emitted light in said first mode having an overall SPD power and a blue SPD power from 440 nm to 490 nm, wherein said blue SPD power is no greater than 2% of said overall SPD power, said emitted light in said first mode being at least 0.005 Duv above the blackbody curve.

In one embodiment, the power supply is configured to power said first and second light sources to emit said emitted light in a second mode, said emitted light in said second mode comprising a reduced portion of said first light, said emitted light in said second mode having an overall SPD power and a blue SPD power from 440 nm to 490 nm, wherein said blue SPD power is no greater than 1% of said overall SPD power in said second mode.

in one embodiment, the present invention relates to a method of operating a lighting system to light an outdoor area comprising: powering at least one of a first light source or a second light source of said lighting system to emit first emitted light in at least a first mode, said first light source having at least one first LED and one or more first light converting materials for emitting said first light, said first light being a green light, said second light source having at least one second LED and one or more second light converting materials for emitting said second light, said second light being a red light, said first light source and said second light source being isolated such that said first and second LEDs do not excite said second and first light converting materials, respectively; and said emitted light in said first mode having an overall SPD power and a blue SPD power from 440 nm to 490 nm, wherein said blue SPD power is no greater than 2% of said overall SPD power, said emitted light in said first mode being at least 0.005 Duv above the blackbody curve.

### BRIEF DESCRIPTION OF FIGURES

FIG. 1 shows one embodiment of the outdoor lighting system of the present invention.

FIGS. 2A-2E shows the spectral power distribution (SPD) of various embodiments of the present invention listed in Table 2.

FIG. 3 is a chromaticity diagram showing and defining the regions of the first and second light and the emitted light.

FIG. 4 shows the SPD of one of the embodiments listed in Table 2 (QH1a) compared to both Phosphor Amber and 1800K.

FIG. 5 a prototype PCB built with LEDs using the QH1a configuration in a room with the red chairs and a green recycling bin. phosphor amber would tint both more orange than this, and while 1800K render the red chairs than that Phosphor Amber, it would not render green as well, plus it would have substantially more blue content.

### DETAILED DESCRIPTION

Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

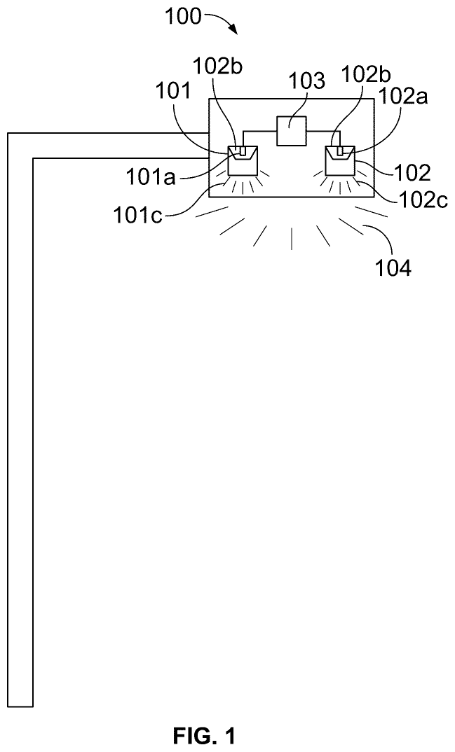

Referring to FIG. 1, one embodiment of the outdoor lighting system 100 of the present invention is shown. The system 100 comprises a first light source 101 having at least one first LED 101a and one or more first light converting materials 101b for emitting a first light 101c. The first light is a green light. The system 100 also comprises a second light source 102 having at least one second LED 102a and one or more second light converting materials 102b for emitting the second light 102c. The second light is a red light. In one embodiment, the first light source and the second light source are isolated such that the first and second LEDs do not excite the second and first light converting materials, respectively. In one embodiment, the system 100 comprises a power supply 103 for powering the first and second light sources to emit emitted light 103 in at least a first mode. The emitted light in the first mode has an overall SPD power and a blue SPD power from 440 nm to 490 nm, wherein the blue SPD power is no greater than 2% of the overall SPD power. The emitted light in the first mode is at least 0.005 Duv above the blackbody curve. These features are described in greater detail and with respect to selected alternative embodiments below.

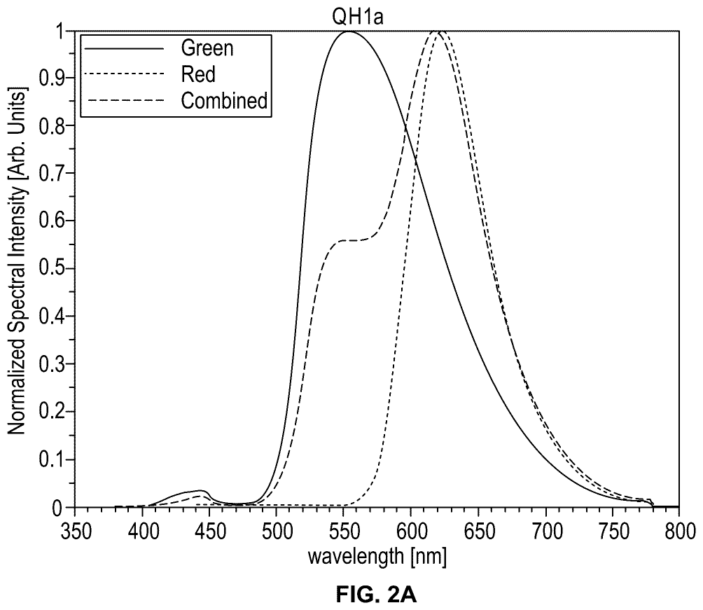

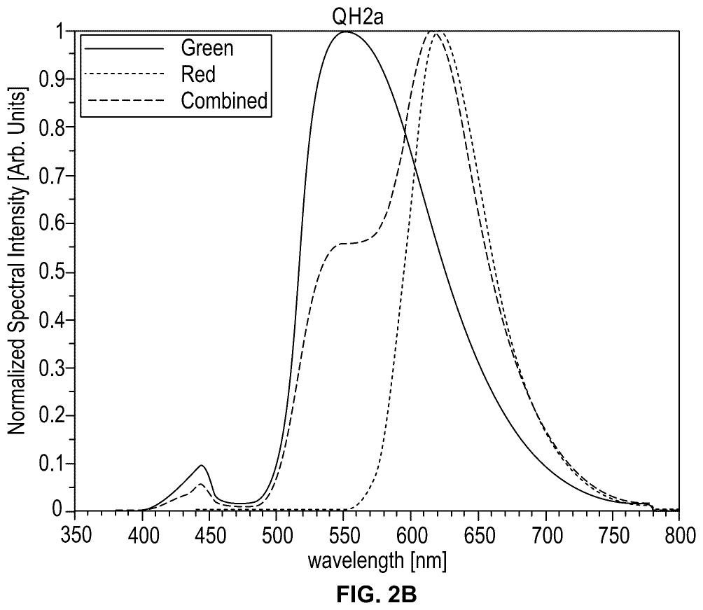

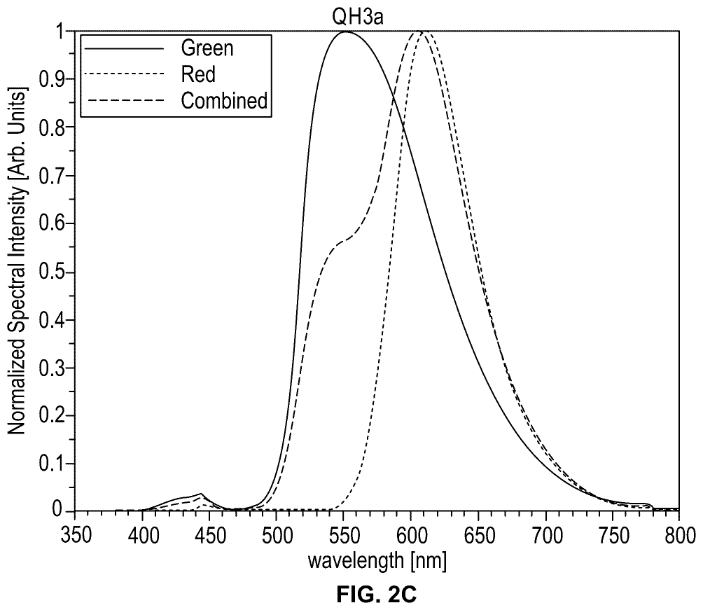

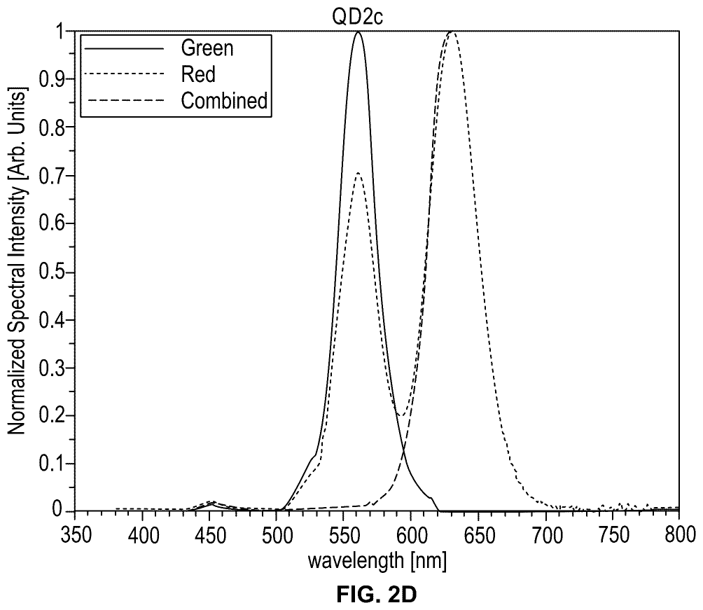

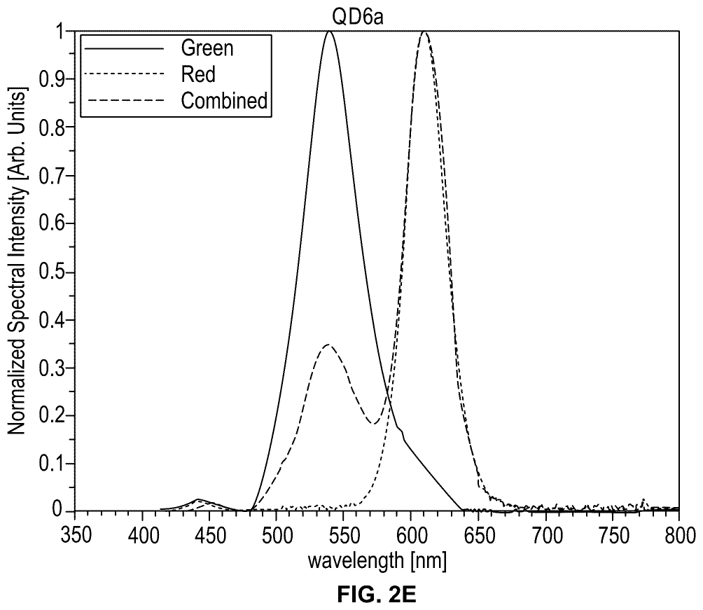

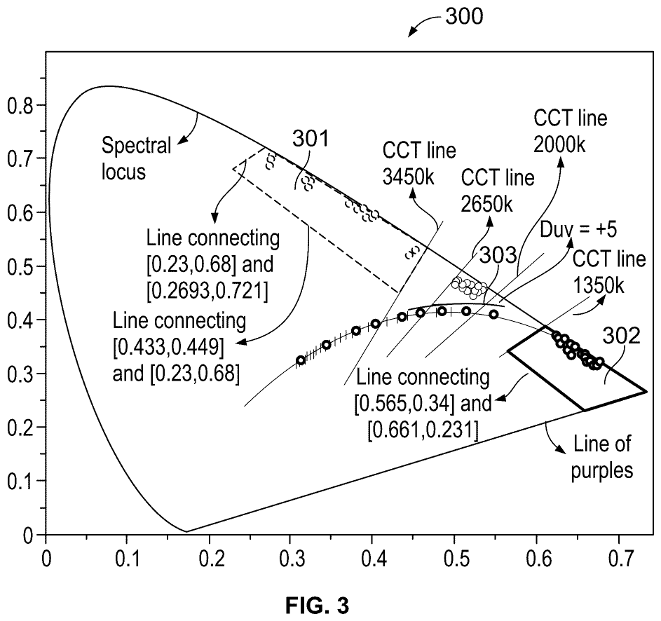

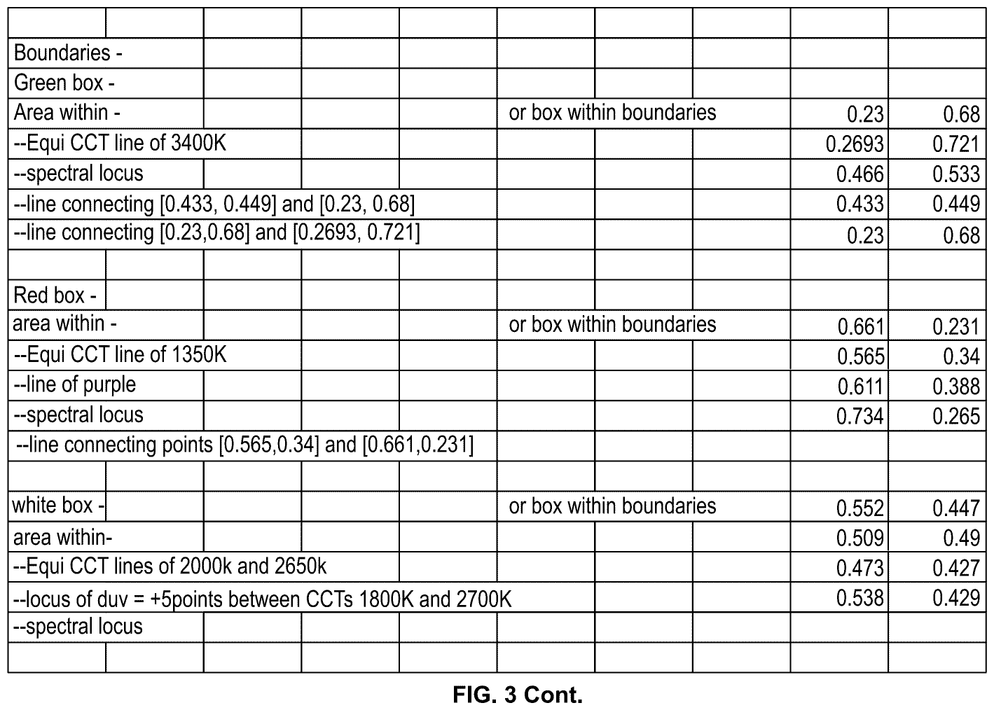

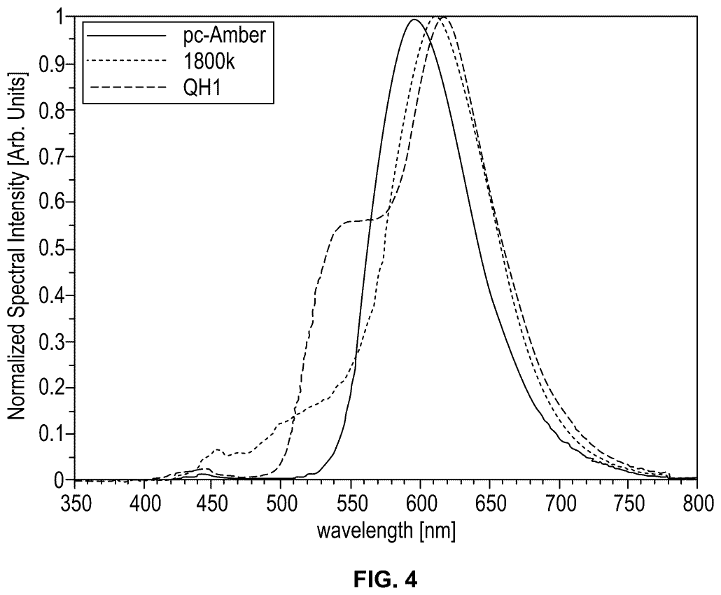

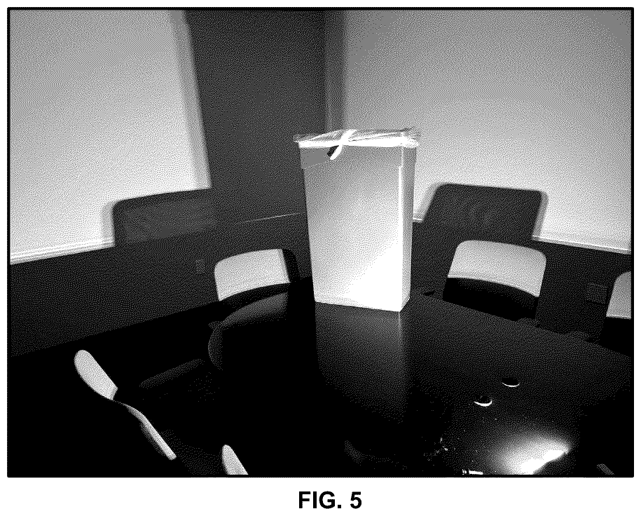

The emitted light in the first mode is optimized for high photonic efficiency and visual acuity/light quality, while minimizing circadian disruption and Dark Sky and environmental impact. Referring to FIG. 3, a chromaticity diagram 300 of one embodiment of the invention is shown which defines the regions of the first light 301, the second light 302 and the emitted light 303. Also shown is a table defining the first, second and emitted light regions both in terms of boundaries and in terms of xy coordinates. Also, referring to FIGS. 2A-2E, the spectral power distribution (SPD) for the first, second and emitted lights are shown of various embodiments of the present invention listed in Table 2. FIG. 4 shows the SPD of one of the embodiments listed in Table 2 (QH1a) compared to both Phosphor Amber and 1800K. The green content of this embodiment, allows for greater red/green differentiation. For example, in one embodiment, as shown in FIG. 5, red and green objects are rendered properly and are readily discernible with this light. This is important as conventional low blue outdoor lighting tends to render objects as orange regardless of their color, thus greatly diminishing a person's ability to recognize/identify color of an automobile or a person's clothing.

In one embodiment, the emitted light of the first mode is configured for visual acuity to provide sufficient brightness and light quality to discern different colors. The present invention overcomes this provides by emitting emitted light in the first mode having relative high CRI and TM-30 Rf values and low blue content. In one embodiment, the emitted light in the first mode has a CRI Ra of at least 70, or at least 75, or at least 80. In one embodiment, the emitted light in the first mode has a CRI R9 greater than 0, or at least 10, or at least 20. In one embodiment, the emitted light in the first mode has a TM-30 Rf of at least 60, or at least 65. In one embodiment, the emitted light in the first mode has a TM-30 Rg of at least 60, or at least 65. In one embodiment, the emitted light in the first mode has a CCT above phosphor amber and 1800 K. In one embodiment, the CCT is of greater than 1800 k, or at least 1900K, or at least 2000K, or at least 2100K, or at least 2200K or at least 2300K, or at least 2400K, or 1800K to 2500 k, or 2200-2500K.

In one embodiment, the emitted light in the first mode has high photonic efficiency. For example, in one embodiment, the lumens per watt (LPW) at least 120, or at least 130, or at least 140, or at least 150, or at least 160, or 120-160, or 130-150. The sufficiency is to in large part to Applicant recognizing that conventional “white light” was not as important for outdoor lighting as light having a perceived high brightness. Accordingly, in one embodiment, the first light source is not white light but is well above the blackbody curve (BBC). In one embodiment, the first light is a high photonic green light, having a peak wavelength from 540 nm to 555 nm, or 543 nm to 552 nm, and at least 10 MacAdams above the BBC, or 10-20 MacAdams above the BBC, or 12-17 MacAdams above the BBC, or 14-16 MacAdams above the BBC. The resulting emitted light in the first mode is above the BBC by at least 0.005 Duv, or at least 0.01 Duv, or at least 0.011 Duv, or at least 0.012 Duv, or at least 0.014 Duv.

The emitted light in the first mode is also configured to minimize circadian stimulation, sky glow, and environmental impact on flora and fauna. To that end, the emitted light in the first mode has very little blue light. In one embodiment, the blue SPD power is no greater than 2% of the overall SPD power, or the blue SPD power is no greater than 1% of the overall SPD power. Such low blue light results in very little circadian stimulation. In one embodiment, the s/p ratio is less than 1, or is less than 0.9, or is less than 0.8, or is less than 0.7.

In one embodiment, the power supply is configured to power the first and second light sources to emit the emitted light in a second mode, the emitted light in the second mode comprising a reduced portion of the first light. In the second mode, the emitted light has even less blue light, and thus lower impact on circadian stimulation, sky glow, and flora and fauna. In one embodiment, emitted light in the second mode has an overall SPD power and a blue SPD power from 440 nm to 490 nm, wherein the blue SPD power is no greater than 1%, or 0.8%, or 0.7%, or 0.5%, or 0.3%, or 0.2%, or 0.1% of the overall SPD power in the second mode. In one embodiment, the emitted light in the second mode has a s/p ratio of less than 0.5, or less than 0.3, or less than 0.2.

The extent to which the first light is reduced in the emitted light of the second mode can vary. In one embodiment, the emitted light in the second mode has a contribution of the first light of less than 25%, or less than 10%, or 0.

The lighting system of the present invention may be configured in different ways to change the mode of the emitted light. For example, in a simple embodiment, the output of the first and second light sources is balanced such that equal amounts of current flow through each string to provide the correct color point. One advantage of such a configuration is that the first and second light sources could be run in parallel (with or without a current-balancing analog circuit) through a switch (e.g. FET). When the switch is closed, current is divided between the first and second light sources first and second. When the switch is open, current only flows through the second light source. This configuration would allow for a lower cost implementation.

In another embodiment, the power source comprises a controller for independently controlling the first and second light sources. Such a configuration is more complex, but allows for precision control/powering of the first and second light sources. Additionally, the controller can be configured with intelligence for switching between the first and second modes. For example, in one embodiment, the controller is configured to communicate with and occupancy sensor, and switch from the first mode to the second mode when occupancy is determined to be below a threshold. Occupancy relates to people or things requiring outdoor lighting, such as, people, pets, or vehicles. In one embodiment, the threshold is 1. In another embodiment, the controller may be configured to communicate with other outdoor lighting systems in the area and switch between the first and second modes in a coordinated way. For example, occupancy sensor may be positioned near the entrance of a walkway, and, when the occupancy sensor senses a person, it may cause all the lights along the walkway to switch from the second mode to the first mode to provide better lighting for the person.

### Examples

The following non-limiting examples are provided to show the efficacy of the present invention and should not be interpreted as limited the scope of the claims.

In the examples provided in Table 2, both phosphors (QH examples) and Quantum Dots (for red, QD examples) can be used to provide combined light systems capable of efficacies greater than 1800K or Phosphor Amber, while providing excellent low blue performance, similar or greater color quality and visual acuity, and a “red only” mode with s/p ratios below that of even Phosphor Amber.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

TABLE 1

| | | | | | Typical | % blue 440- | s/p | CRI | CRI | TM-30 | TM-30 |
|---|---|---|---|---|---|---|---|---|---|---|---|
| Source | x | y | CCT | duv | LPW | 490 nm | ratio | Ra | R9 | Rf | Rg |
| PC Amber | 0.5738 | 0.4201 | 1704 | 5.2 | 95 | 0.30% | 0.38 | 35 | −117 | 39 | 44 |
| 1800K (Nichia | 0.5452 | 0.4083 | 1829 | −0.3 | 115 | 2.90% | 0.76 | 71.7 | −27.6 | 76 | 89 |
| NVSW219F-1856 | | | | | | | | | | | |
| 2000K (Nichia | 0.5282 | 0.4124 | 1983 | −0.2 | 135 | 2.80% | 0.79 | 72.2 | −19.5 | 76 | 98 |
| NVSW219F-205) | | | | | | | | | | | |
| 2200K (Nichia | 0.5029 | 0.4162 | 2234 | 0.3 | 145 | 3.90% | 0.92 | 75.6 | −13.7 | 74 | 97 |
| NVSW219F-225) | | | | | | | | | | | |
| 2500K (Nichia | 0.4812 | 0.4146 | 2457 | 0.2 | 145 | 5.20% | 1.04 | 77.7 | −27.6 | 71 | 96 |
| NVSW219F-255) | | | | | | | | | | | |

TABLE 2

| | | | | | Typical | % blue 440- | s/p | CRI | CRI | TM-30 | TM-30 |
|---|---|---|---|---|---|---|---|---|---|---|---|
| Source | x | y | CCT | duv | LPW | 490 nm | ratio | Ra | R9 | Rf | Rg |
| PC Amber | 0.5738 | 0.4201 | 1704 | 5.2 | 95 | 0.30% | 0.38 | 35 | −117 | 39 | 44 |
| 1800K (Nichia | 0.5452 | 0.4083 | 1829 | −0.3 | 115 | 2.90% | 0.76 | 71.7 | −27.6 | 76 | 89 |
| NVSW219F-1856 | | | | | | | | | | | |
| 2000K (Nichta | 0.5282 | 0.4124 | 1983 | −0.2 | 135 | 2.80% | 0.79 | 72.2 | −19.5 | 76 | 98 |
| NV8W219F-205) | | | | | | | | | | | |
| 2200K (Nichia | 0.5029 | 0.4162 | 2234 | 0.3 | 145 | 3.90% | 0.92 | 75.6 | −13.7 | 74 | 97 |
| NVSW219F-225) | | | | | | | | | | | |
| 2500K (Nichia | 0.4812 | 0.4146 | 2457 | 0.2 | 145 | 5.20% | 1.04 | 77.7 | −27.6 | 71 | 96 |
| NVSW219F-255) | | | | | | | | | | | |
| New system | | | | | | | | | | | |
| QH1a - combined | 0.5196 | 0.4629 | 2373 | 14.3 | 120-140 | 0.40% | 0.85 | 80 | 20 | 62 | 62 |
| QH1a - red only | 0.6592 | 0.3373 | n/a | n/a | 60-70 | 0.10% | 0.13 | n/a | n/a | n/a | n/a |
| QH2a - combined | 0.5126 | 0.4584 | 2413 | 13.1 | 120-140 | 0.90% | 0.89 | 82 | 23 | 77 | 79 |
| QH2a - red only | 0.6592 | 0.3373 | n/a | n/a | 60-70 | 0.10% | 0.13 | n/a | n/a | n/a | n/a |
| QH3a - combined | 0.5158 | 0.4661 | 2430 | 15.3 | 130-150 | 0.60% | 0.83 | 71 | −26 | 61 | 61 |
| QH3a - red only | 0.6296 | 0.3634 | n/a | n/a | 70-80 | 0.40% | 0.2 | n/a | n/a | n/a | n/a |
| QD2c - combined | 0.5325 | 0.4545 | 2203 | 11.9 | 120-140 | 0.60% | 0.66 | 74 | 88 | 61 | 69 |
| QD2c - red only | 0.6716 | 0.3142 | n/a | n/a | 60-70 | 0.70% | 0.15 | n/a | n/a | n/a | n/a |
| QD6a - combined | 0.5246 | 0.4492 | 2241 | 10.3 | 140-160 | 0.90% | 0.92 | 83 | −51 | 68 | 73 |
| QD6a - red only | 0.6911 | 0.354 | n/a | n/a | 80-100 | 0.80% | 0.2 | n/a | n/a | n/a | n/a |

What is claimed is:

1. An outdoor lighting system for emitting emitted light, comprising:
a first light source having at least one first LED and one or more first light converting materials for emitting said first light, said first light being a green light;
a second light source having at least one second LED and one or more second light converting materials for emitting said second light, said second light being a red light;
wherein said first light source and said second light source being isolated such that said first and second LEDs do not excite said second and first light converting materials, respectively; and
a power supply for powering said first and second light sources to emit said emitted light in at least a first mode, said emitted light in said first mode having an overall SPD power and a blue SPD power from 440 nm to 490 nm, wherein said blue SPD power is no greater than 2% of said overall SPD power, said emitted light in said first mode being at least 0.005 Duv above the blackbody curve.

2. The outdoor lighting system of claim 1, wherein said emitted light in said first mode has a CCT of 1800 k to 2500 k.

3. The outdoor lighting system of claim 1, wherein said emitted light in said first mode has a CRI of at least 80.

4. The outdoor lighting system of claim 1, wherein said emitted light in said first mode has a TM-30 Rf of at least 60

5. The outdoor lighting system of claim 1, wherein said emitted light in said first mode has a s/p ratio of less than 1.

6. The outdoor lighting system of claim 1, wherein said blue SPD power is no greater than 1% of said overall SPD power.

7. The outdoor lighting system of claim 1, wherein said emitted light in said first mode has a minimum LPW of 120.

8. The outdoor lighting system of claim 1, wherein said emitted light in said first mode being at least 0.01 Duv above the blackbody curve.

9. The outdoor lighting system of claim 1, wherein said power supply is configured to power said first and second light sources to emit said emitted light in a second mode, said emitted light in said second mode comprising a reduced portion of said first light, said emitted light in said second mode having an overall SPD power and a blue SPD power from 440 nm to 490 nm, wherein said blue SPD power is no greater than 1% of said overall SPD power in said second mode.

10. The outdoor lighting system of claim 9, wherein said emitted light in said second mode has a s/p ratio of less than 0.5, or less than 0.3, or less than 0.2.

11. The outdoor lighting system of claim 9, wherein said power supply is balanced between each of said first and second light sources in said first mode.

12. The outdoor lighting system of claim 11, wherein said power supply is configured to power said first and second light sources in at least a second mode in which power is provided only to said second light source to emit emitted light in said second mode.

13. The outdoor lighting system of claim 12, wherein said power source comprises a switch, wherein, when switch is in a first position, said power source powers said first and second light sources in said first mode, and, when switch is in a second position, said power source powers only said second light source in said second mode.

14. The outdoor lighting system of claim 13, wherein said switch is a FET.

15. The outdoor lighting system of claim 9, wherein said power source comprises a controller for independently controlling said first and second light sources.

16. The outdoor lighting system of claim 15, wherein said controller switches from said first mode to said second mode when occupancy is determined to be below a threshold.

17. The outdoor lighting system of claim 16, wherein said occupancy relates to at least a certain number of people in an area or a certain number of vehicles in an area.

18. The outdoor lighting system of claim 17, wherein said certain number of people is 0 and said certain number of vehicles is 0.

19. The outdoor lighting system of claim 9, wherein said emitted light in said second mode has a contribution of said first light of less than 25%, or less than 10%, or 0.

20. A method of operating a lighting system to light an outdoor area comprising:
powering at least one of a first light source or a second light source of said lighting system to emit first emitted light in at least a first mode, said first light source having at least one first LED and one or more first light converting materials for emitting said first light, said first light being a green light, said second light source having at least one second LED and one or more second light converting materials for emitting said second light, said second light being a red light, said first light source and said second light source being isolated such that said first and second LEDs do not excite said second and first light converting materials, respectively; and
said emitted light in said first mode having an overall SPD power and a blue SPD power from 440 nm to 490 nm, wherein said blue SPD power is no greater than 2% of said overall SPD power, said emitted light in said first mode being at least 0.005 Duv above the blackbody curve.

21. The method of claim 20, wherein said first and second light sources are powered in said first mode.

22. The method of claim 20, further comprising:
switching between said first mode and a second mode, in said second mode,
said lighting system emitting a second emitted light in a second mode,
said second emitted light having a reduced amount of said green light compared to said first emitted light.

23. The method of claim 22, wherein switching between said first and said second modes is triggered by an occupancy sensor.
